(19) United States
(12) Patent Application Publication
(10) Pub. No.: US 2016/0341542 A1
(43) Pub. Date: Nov. 24, 2016

(54) MEASUREMENT SYSTEM AND METHOD

(71) Applicant: Wal-Mart Stores, Inc., Bentonville, AR (US)

(72) Inventors: Donald High, Noel, MO (US); Brian Gerard McHale, Oldham (GB)

(21) Appl. No.: 15/159,423

(22) Filed: May 19, 2016

Related U.S. Application Data
(60) Provisional application No. 62/163,584, filed on May 19, 2015.

(51) Int. Cl. G01B 11/02; G01B 17/00

(52) U.S. Cl. CPC G01B 11/02; G01B 17/00

(57) ABSTRACT

Exemplary embodiments of the present disclosure are directed to measuring lengths in a physical environment using one or more sensors. The sensors can be arranged in one or more configurations and can use one or more methodologies for carrying the measurement of lengths.

### CROSS-REFERENCE TO RELATED PATENT APPLICATIONS

This application claims priority to and benefit of U.S. Provisional Patent Application No. 62/163,584, filed May 19, 2015 the disclosure of which is incorporated herein by reference in its entirety.

### FIELD OF THE INVENTION

This invention relates to measurement systems and methods.

### BACKGROUND OF THE INVENTION

In recent years, both the floor space and the opening hours of modern retail stores have substantially increased, with large out-of-town stores which are open 24 hours a day common. The number of customers in store at a given time can vary considerably depending on the time of day, the day of the week, and a variety of other pertinent factors.

Typically, customers browse the items held on display units throughout the store, select the items they desire and place them in a shopping trolley or shopping basket, before proceeding to a checkout to pay for the items. Usually, the number of checkouts provided in the store is chosen so as to cope efficiently with busy periods in the store. However, not all of the checkouts need to be open all of the time, and in quieter periods only a proportion of the checkouts in the store are available for customer use.

Conventionally, the decision as to the proportion of the checkouts available for customer use is taken by a member of staff who assesses the length of queue at the open checkouts and opens or closes checkouts accordingly. However, problems arise in that it can be difficult to assess queue length in stores having a large number of checkouts, or where the checkouts are not all disposed in the same area of the store. In the case where too few checkouts are opened, customer satisfaction is negatively impacted. In the case where too many checkouts are opened, staff resources are misused by manning a checkout with little or no queue.

It is an object of the present invention to address these problems, and any other problems which may be apparent from the description below.

### SUMMARY

In accordance with embodiments of the present disclosure, a measurement system is disclosed that includes: at least one sensor array disposed at a position corresponding to a respective area and comprising a plurality of sensors, each sensor configured to measure a distance in each area and transmit the measured distance; a storage operable to store a plurality of first distances corresponding to each area in an empty state; a controller configured receive a plurality of second distances from each sensor array, and to determine a length of a queue in each queuing area by comparing corresponding first stored distances and second distances.

In some embodiments, the controller is further configured to receive the first distances from the or each sensor array and store the received first distances in the storage.

In some embodiments, the or each sensor array comprises at least one sensor mounted above the respective queuing area and configured to measure the distance in a downward direction.

In some embodiments, the or each sensor array comprises a plurality of sensors mounted above the respective queuing area and configured to measure the distance in a downward direction mounted a predetermined distance apart.

In some embodiments, the or each sensor array comprises five sensors mounted above the respective area and configured to measure the distance in the downward direction.

In some embodiments, the or each sensor array comprises at least one sensor disposed at an end of the respective area and configured to measure the distance in a horizontal direction.

In some embodiments, the or each sensor array comprises two sensors disposed at opposing ends of the respective queuing area and configured to measure the distance in the horizontal direction.

In some embodiments, the controller is configured to determine that each area is empty if the second distances are substantially equal to the first stored distances.

In some embodiments, the controller is configured to determine that an object is present in a region of the or each area corresponding to each sensor if the difference between the first and second distances corresponding to the sensor exceeds a predetermined threshold.

In some embodiments, the controller is configured to determine a start point and an end point of the queue in each area based on the presence of an object in the region of each area corresponding to each sensor, and to determine the length of the queue in each area based on a distance between the start point and the end point.

In some embodiments, at least one sensor comprises: an emitter operable to emit a signal, and a receiver operable to measure a quantity of the emitted signal reflected from an object, so as to determine a distance between the sensor and the object.

In some embodiments, the signal is modulated light.

In some embodiments, the signal is a laser pulse.

In some embodiments, the signal is a sound wave.

In some embodiments, the system further comprises a terminal operable to receive and display queue information, wherein the controller is configured to periodically store the determined length of the queue in each area in the storage, and wherein the controller is configured to control the terminal to display an alert when the controller determines that the length of the queue in at least one the areas has exceeded a predetermined length for a predetermined amount of time.

In some embodiments, the controller is configured to determine a fill level of one or more trollies in the or each area, based on the measured distance in the downward direction.

In some embodiments, each area corresponds to a terminal, and the controller is configured to activate the respective sensor array of one of the areas when the respective terminal is activated.

In accordance with embodiments of the present disclosure, a method of measuring length includes: storing a plurality of first distances corresponding to an area in an empty state obtaining a plurality of second distances using a sensor array disposed at a position corresponding to the area and comprising a plurality of sensors arranged to measure a distance in the area, and determining a length of a queue in the area by comparing corresponding first stored distances and second distances.

Any combination or permutation of the embodiments is envisioned. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

For a better understanding of example embodiments, and to show how example embodiments of the may be carried into effect, reference will now be made, by way of example, to the accompanying diagrammatic drawings in which:

FIG. 1 is a schematic plan view of an exemplary retail store in which an exemplary measurement system operates;

FIG. 2 is a block diagram of an exemplary measurement system;

FIGS. 3A-C are schematic side views of an exemplary measurement system in operation;

FIGS. 4A-C are schematic side views of a further exemplary measurement system in operation;

FIG. 5 is a flowchart of an exemplary method of measuring a length;

FIG. 6 is a block diagram of an exemplary computing device configured to implement embodiments of the present disclosure;

### DETAILED DESCRIPTION

Exemplary embodiments of the present disclosure are directed to measuring lengths in a physical environment using one or more sensors. In exemplary embodiments, the lengths can be calculated in terms of distance units (e.g., meters, feet), an estimated number of people or trolleys (i.e. carts) in a queue, an estimated time (e.g., seconds, minutes), and/or in terms of fill levels of the trolleys in the queues. The sensors can be arranged in one or more configurations and can use one or more methodologies for carrying the measurement of lengths.

The following description is presented to enable any person skilled in the art to create and use a measurement system configuration and related method and article of manufacture to measure queues of checkouts in a physical environment, such as a store. Various modifications to the example embodiments will be readily apparent to those skilled in the art, and the principles defined herein may be applied to other embodiments and applications without departing from the spirit and scope of the invention. Thus, the present disclosure is not intended to be limited to the embodiments shown, but is to be accorded the widest scope consistent with the principles and features disclosed herein.

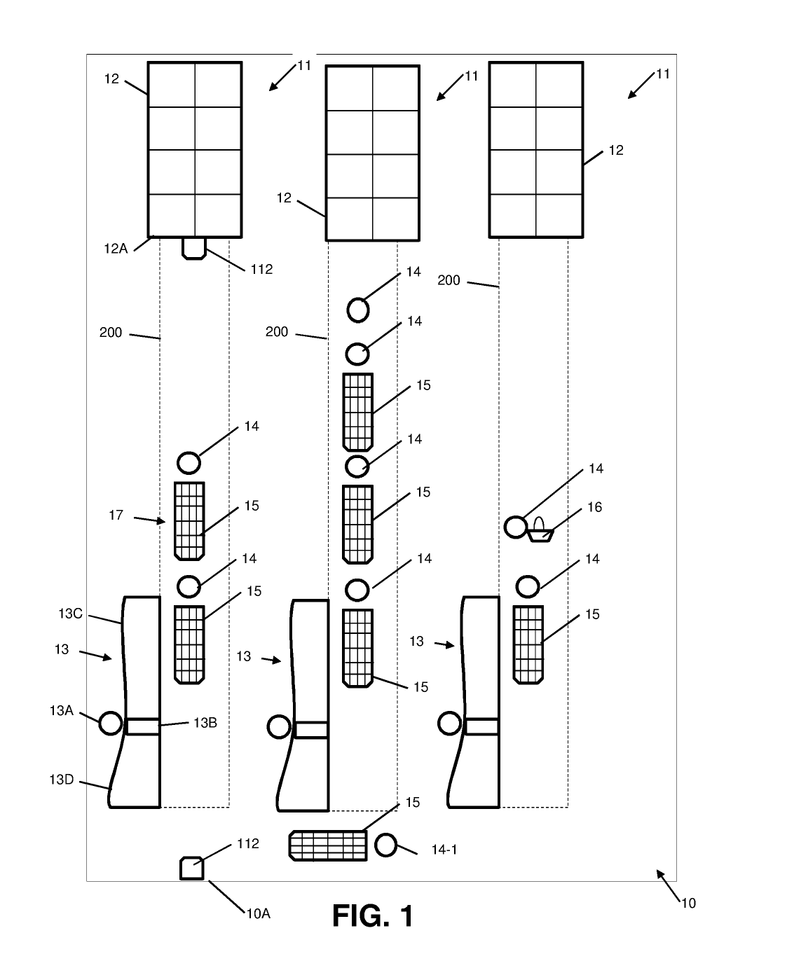

FIG. 1 shows a schematic view of a physical environment in which embodiments of the invention may operate. The physical environment may be a retail store 10. The retail store 10 comprises a plurality of display units 12, which store and display items (not shown) available for sale. Typically, the display units 12 are arranged so as to define a plurality of aisles 11, though it will be understood that a variety of arrangements may be employed for storing and displaying items.

Customers 14 move around the retail store 10, progressing up and down the aisles 11 and selecting the items that they wish to purchase. Depending upon the quantity and volume of the items selected, the customers 14 may place the goods in a shopping trolley 15, a handheld basked 16, or simply elect to carry the items.

The retail store 10 further comprises a plurality of checkouts 13. Typically the checkouts 13 are arranged in one area of the retail store 10. As non-limiting example, the checkouts 13 can be arranged proximate to an exit of the retail store 10. After each customer 14 has selected the items they desire, they pay for the items at one of the checkouts 13.

In one example, the checkouts 13 comprise a conveyor belt 13C, an electronic point of sale system or terminal 13B (hereinafter EPOS) and a bagging area 13D. The customers 14 unload the items onto the conveyor belt 13C, which conveys the items toward the EPOS 13B. The EPOS 13B is configured to identify the items (e.g. by a barcode scan), retrieve the price associated therewith, calculate the amount owed by the customer 14 and provide a mechanism for allowing the customer 14 to make payment. In one example, the EPOS 13B is operated by a member of staff 13A. In other examples, the EPOS 13B may be a self-serve EPOS 13B operated by a customer 14 rather than a member of staff 13A. The bagging area 13D is an area in which materials are provided for packing the items after the items have been processed by the EPOS 13B. Typically, the bagging area 13D comprises an inclined surface so as to convey the processed items away from the EPOS 13B and towards a customer 14 at the end of the bagging area. It will be understood by those skilled in the art that different configurations of checkout 13—such as express checkouts lacking conveyor belts 13C—may be employed, and the embodiments described below are not dependent on any particular configuration. Similarly, the location of the checkouts 13 within the retail store 10 may be varied depending upon the needs and desires of the store operator and the physical layout of the retail store 10.

Often, there are more customers 14 wishing to pay for their items than checkouts 13 in operation. In such a circumstance, the customers 14 form a queue 17 (also referred to as a line), and wait to be served at a checkout 13. Typically, one queue 17 is formed per checkout 13 in operation. Queues 17 can be encouraged—by the layout of the retail store 10 and/or by members of staff 13A—to form in areas 200 in an orderly fashion. The areas 200 in which the queues 17 can be formed are monitored by one or more instances of a measurement system 100, as described in accordance with the exemplary embodiments below.

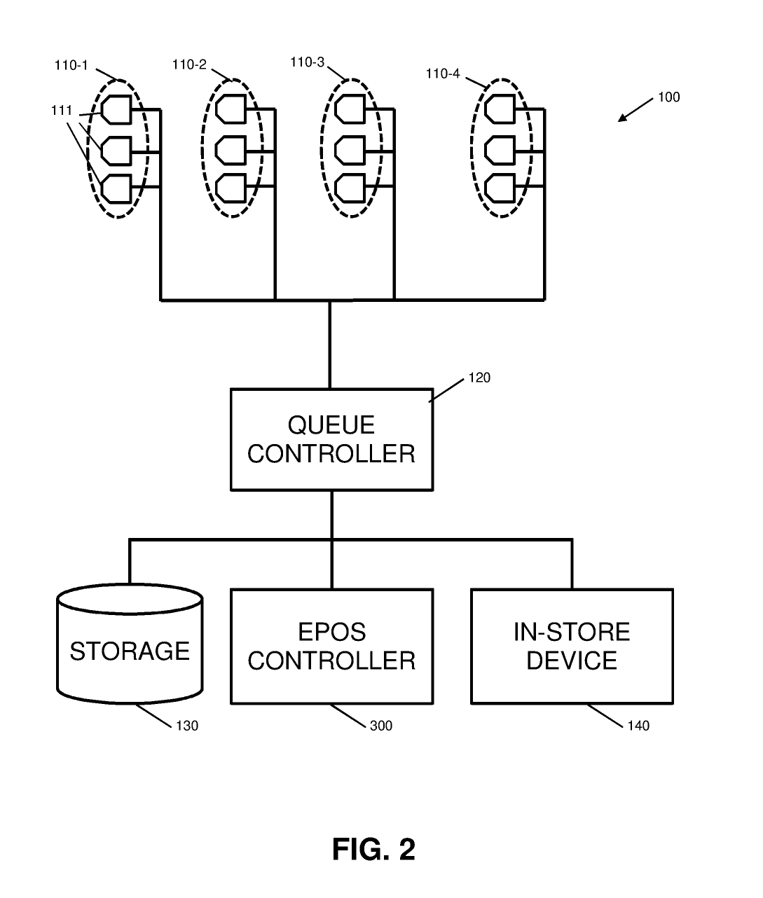

FIG. 2 shows an schematic diagram of a measurement system 100 according to an exemplary embodiment of the invention.

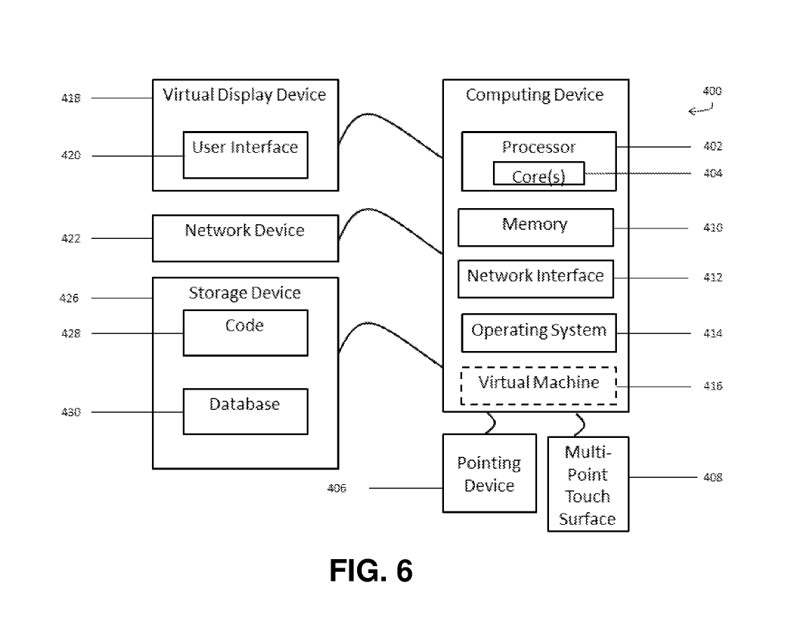

In one example, the system 100 comprises a plurality of sensor arrays 110-1, 110-2, 110-3, 110-4, a queue controller 120 and a storage 130. The sensor arrays 110, the queue controller 120 and storage 130 may be linked by a communication network. The network may take any suitable form, including one or more wired and/or wireless communication links, as will be familiar to those skilled in the art. The queue controller 120 and storage 130 may be a single device, such as a local store server. A non-limiting example, of a server that can be used to implement the queue controller 120 is shown in FIG. 6.

Each of the sensor arrays 110 comprises a plurality of sensors 111. Each sensor 111 is configured to measure a distance to the nearest object in a predetermined measurement direction. In one example, each sensor 111 comprises an emitter (not shown) and a receiver (not shown). The emitter emits a signal, and the receiver measures the quantity of the emitted signal which is reflected by the object. The receiver may also be configured to calculate the time elapsed between signal emission and receipt of the reflection. The sensor 111 is configured to calculate the distance based on the measured quantity and/or the time elapsed.

In one example, the sensor 111 is a visible light sensor. In the example, the emitter comprises at least one LED configured to broadcast a signal comprising modulated visible light towards the object, and the receiver comprises a photo receiver configured to receive and measure the modulated visible light. In one example, the emitter is an LED light fixture produced by ByteLight™.

In a further example, the sensor 111 is a laser rangefinder sensor. In the example, emitter is configured to emit a laser pulse towards the object, and the receiver is a sensor configured to receive and measure the reflected laser pulse.

In a further example, the sensor 111 is an ultrasonic rangefinder sensor. In the example, emitter is configured to emit an ultrasonic pulse towards the object, and the receiver is a sensor configured to receive and measure the reflected sound wave.

It will be understood that each sensor array 110 may comprise a mixture of sensor types. It will be further understood that differing sensor technologies could also be employed where appropriate.

The sensors 111 of each sensor array 110 are disposed around a respective one of the queuing areas 200 so as to measure the length of a respective one of the queues 17 formed therein.

Referring back to FIG. 1, the sensors 111 in the sensor array 110 (FIG. 2) may comprise one or more sensors 112 mounted on a substantially vertical surface, and configured to measure a distance in a substantially horizontal direction. The sensors 112 may be mounted so as to measure the distance to the front end of the queue 17 and the rear end of the queue 17. In one example, the sensors 112 may be disposed on an end 12A of a proximate display unit 12. In one example, the sensors 112 may be disposed on a rear or front wall 10a of the retail store 10. However, it will be understood that the sensors 112 may be mounted on any suitable substantially vertical surface.

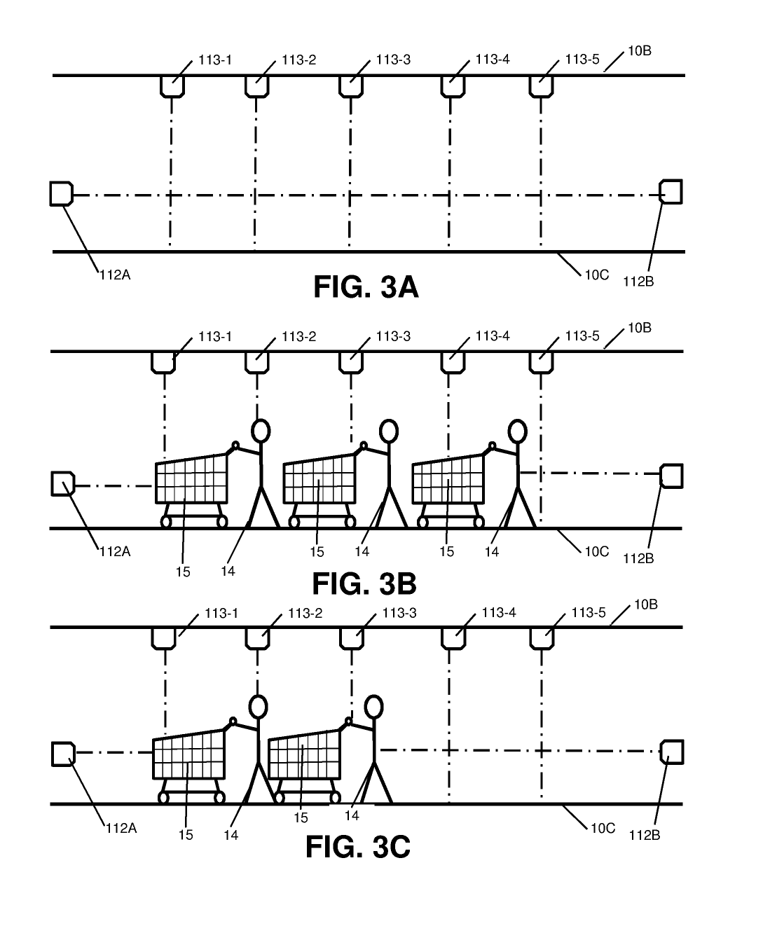

Referring to FIGS. 3A-C, which show a side view of the queuing area 200, the sensors 111 of the sensor array 110 (FIG. 2) may also or alternatively comprise one or more sensors 113 mounted on a substantially horizontal surface which are configured to measure a distance in a substantially vertical direction. The sensors 113 may be mounted on a roof or ceiling 10B of the retail store 10, or suspended above the queuing area 200 by any other suitable means, and configured to measure the distance in a downward direction towards the floor 100. In a further example, the sensors 113 may be recessed into the floor 10c and configured to measure the distance in an upward direction towards the roof or ceiling 10B.

Referring again to FIG. 2, the storage 130 is configured to store baseline distance measurements corresponding to each of the sensor arrays 110. The baseline distance measurements may be predetermined expected measurements pre-stored in the storage 130. Alternatively, the baseline distance measurements may correspond to distance measurements captured when the queuing area 200 is in a substantially empty state—i.e. when no queue 17 is present.

In one example, the storage 130 is further configured to store the determined length of the queue 17 present in each queuing area 200. Particularly, the storage 130 holds the determined length as calculated at predetermined time intervals (e.g. once per minute or once per five minutes).

The queue controller 120 is configured to receive a plurality of distance measurements from each sensor array 110, the received distance measurements correspond to measurements captured by the sensors 111 (e.g., sensors 112 shown in FIG. 1, sensors 113 shown in FIGS. 3A-C) of each sensor array 110. The queue controller 120 retrieves the stored baseline measurements corresponding to a sensor array 110 from the storage 130, and compares the baseline measurements with the received distance measurements for that sensor array 110. The queue controller 120 then determines the length of the queue 17 based on the comparison.

FIGS. 3A-3C show a side view of a queuing area 200 in which an exemplary system 100 is in use.

In this particular example, the sensors 111 of the sensor array 110 (FIG. 2) includes two of the sensors 112 (e.g., sensor 112A, sensor 112B) configured to measure a distance in a substantially horizontal direction. The sensor 112A is disposed to measure the distance to the front end of the queue. The sensor 112B is disposed to measure the distance to the rear end of the queue. The sensor array 110 also comprises five of the sensors 113 disposed above the queuing area 200 so as to measure the distance in a substantially vertical direction.

Firstly, as shown in FIG. 3A, the sensor array 110 captures baseline measurement of the queuing area 200 in an empty state—i.e. when no queue is present. The sensors 113 capture a baseline measurement which corresponds to the distance between each sensor 113 and the floor 10c. The sensors 112 capture a baseline measurement which corresponds to the distance between the vertical surfaces on which an opposing one of the sensors 112 is mounted.

With reference again to FIG. 2, the queue controller 120 receives the baseline measurements for the sensor array 110 and stores the measurements in the storage 130. In one example, the process of capturing baseline measurements may be carried out during installation of the system. The baseline measurements may be updated when necessary, such as when the store is reconfigured, or on a periodic basis so as to ensure accurate queue length measurement. Alternatively, the baseline measurements may be pre-calculated and stored based on the measured dimensions of the queuing area 200.

In operation, the sensor array 110 takes distance measurements which are received by the controller 120. The controller 120 then compares the received distance measurements to the baseline measurements for the sensor array 110.

The queue controller 120 may determine that the captured measurements are equal to the baseline measurement, or within a predetermined tolerance range thereof. In such a case, the queue controller 120 determines that the queuing area 200 is empty, and thus no queue 17 is present therein.

The queue controller 120 may determine that one or more of the captured measurements differ from, or are outside a predetermined tolerance range of, their respective baseline measurements. For example, as shown in FIG. 3B, the sensor 113-5 captures a measurement substantially equal to the corresponding baseline measurement, indicating that no object is present in the area under the sensor 113-5. The sensors 113-1, 113-2, 113-3, 113-4 each capture a distance measurement less than the stored baseline, indicating that an object (a trolley 15 or a customer 14) is disposed between each sensor and the floor 100. The sensors 112A and 112B each capture a distance measurement which is less than the stored baseline, also indicating the presence of objects in the queuing area 200.

Having determined that one or more of the captured measurements differ from, or are outside a predetermined tolerance range of, their respective baseline measurements, the queue controller 120 is configured to estimate the length of the queue 17 based on the captured measurements. In one example, the queue length is calculated in terms of distance units (e.g. metres, feet). In one example, the queue length is calculated in terms of the estimated number of customers 14 or trolleys 15 in the queue.

FIG. 3C shows a further example queue, in which two trolleys 15 are present. In this case, the measurements of sensors 113-4 and 113-5 substantially correspond to the baseline measurements, but those of sensors 113-1, 113-2, 113-3, 112A and 112A do not. Consequently, the queue controller 120 (FIG. 2) may establish that the length of the queue 17 is shorter than that of the queue shown in FIG. 3B.

In one example, the queue controller 120 is configured to receive the measurements from the sensor array 110 and perform calculate the queue length at predetermined time intervals. For example, the queue length may be calculated every 10 seconds, every minute, or every 5 minutes. The queue controller 120 may also store the periodically received measurements and/or calculated queue length in the storage 130.

In an example, embodiment, the system 100 further comprises at least one in-store device 140, coupled to the queue controller 120. The in-store device 140 comprises a display (not shown), configured to display the status (such as the queue length) of a plurality of queuing areas 200.

In one example, the in-store device 140 may comprise a fixed terminal situated at a convenient point in the retail store 10 (e.g. at a position manned by a checkout supervisor). In further examples, the in-store device 140 may comprise a portable or wearable device configured to be carried or worn by a member of staff 13A. It will be understood that the in-store device 140 may comprise any suitable computing device.

In use, the queue controller 120 calculates the queue length associated with each queuing area 200 at the above-mentioned predetermined time intervals. The queue controller 120 then updates the display of the in-store device 140, so that staff 13A may easily and conveniently view the respective length of each queuing area 200 within the retail store 10. Consequently, decisions regarding the opening and closing of checkouts 13 may be made more accurately.

In a further example, the controller 120 is configured to generate an alert when certain conditions are met and transmit the alert to the in-store device 140. For example, if a queue length exceeds a certain threshold, the controller 120 may generate and transmit an alert indicating to the member of staff that a further checkout 13 should be opened. In one example, the queue controller 120 may analyse the stored periodically received measurements and generate an alert if the queue length has exceeded a certain threshold for a certain time period. The alert generation process may take into account the queue lengths determined for a plurality of queuing areas 200.

In one example, as shown in FIG. 2, the queue controller 120 is coupled to an EPOS controller 300. The EPOS controller 300 is responsible for controlling the EPOS systems 13b installed in the checkouts 13. The controller queue 120 is configured to receive checkout status data corresponding to the checkouts 13 of each respective queuing area 200. The checkout status data indicates whether each checkout 13 is currently in operation. In use, the controller 120 is configured to only perform queue length determination in respect of sensor arrays 110 associated with checkouts 13 which are currently in operation.

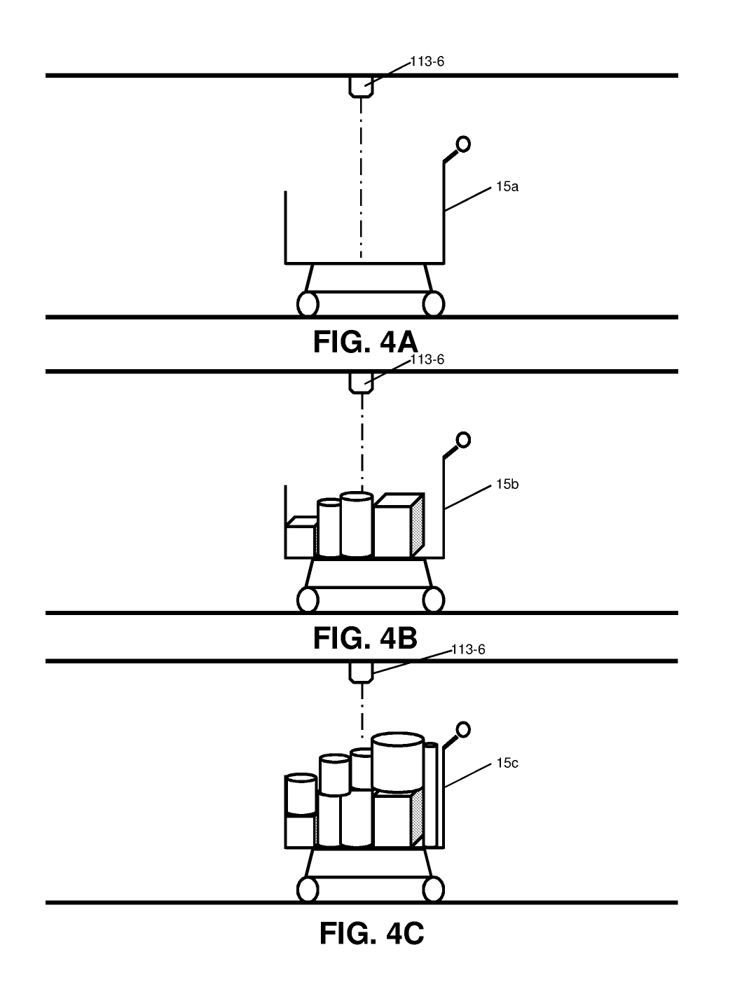

In example embodiments of the present disclosure, the system 100 can be configured to estimate the fill level of one or more shopping trolleys 15. FIG. 4A-C each show a side view of the queuing area 200 in accordance with an embodiment of the invention.

In the example, the storage 130 is further configured to store baseline trolley depth measurements corresponding to one or more sensors 111. The queue controller 120 is further configured to estimate the fill level of a trolley by comparing captured trolley depth values to the stored baseline trolley depth values.

The baseline trolley depth measurements may be measurements pre-stored in the storage 130, based on the known dimensions of shopping trolleys 15 used in the retail store 10.

Alternatively, the baseline trolley depth values may be calculated using an empty trolley 15a. An empty trolley 15a is placed under a sensor 113-6 disposed above the queuing area 200 so as to measure the distance in a substantially vertical direction. The controller 120 receives the baseline measurement from the sensor 113-6—representing the distance to the bottom of the empty trolley 15a—and stores the baseline measurement in the storage 130.

In use, a trolley 15 forms part of the queue 17 in the queuing area 200. At least a part of the trolley 15 is disposed under the sensor 113-6, and the queue controller 120 receives a distance measurement. As outlined above, the queue controller 120 establishes that an object (i.e. trolley 15) is present under the sensor 113-6 by comparing the received measurement to a respective baseline measurement.

Next, the queue controller 120 calculates the difference between the baseline trolley depth value and the received measurement. Based on this difference, the controller may estimate a trolley fill level.

FIG. 4B shows a partially filled trolley 15b. In this instance, the queue controller 120 may calculate the difference between the baseline trolley depth and the received measurement as approximately 0.5m. FIG. 4C shows a fully trolley 15c. In this instance, the queue controller 120 may calculate the difference between the baseline trolley depth and the received measurement as approximately 1.5 m.

In one example, the queue controller 120 next maps the difference to a trolley fill level, based on one or more predetermined thresholds. The thresholds may be stored in the storage 130. For example, the thresholds may map a difference of 0.5 m or less to “partially filled” and a distance of over 0.5 m to “full”. It will be understood that a range of suitable thresholds may be applied, so as to map the difference to a range of suitable fill levels.

In one example, the in-store device 140 is configured to display the fill levels of the trolleys 15 present in each respective queue area 200.

In one example, the queue controller 120 is configured to generate an alert if conditions based on the fill level are met. For example, the queue controller 120 may generate an alert indicating to the member of staff that a further checkout 13 should be opened if the queue length exceeds a predetermined threshold, and a predetermined number of trolleys 15 having the fill level “full” are present.

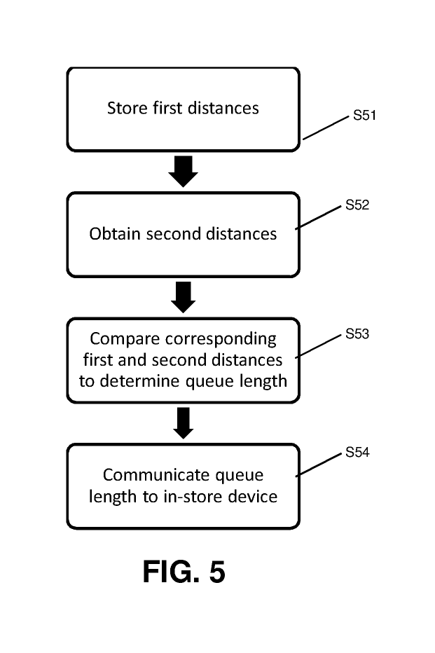

FIG. 5 is a flowchart of an exemplary method for measurement according to the present invention.

Step S51 comprises storing a plurality of first distance measurements corresponding to baseline measurements of a queuing area in an empty state. In one example, the first distance measurements are captured using the sensor array 110 described above.

Step S52 comprises obtaining a plurality of second distance measurements of the queuing area using the sensor array.

Step S53 comprises determining a length of the queue in the queuing area by comparing corresponding first distance measurements and second distance measurements.

Step S54 comprises communicating the determined queue length to an in-store device. In one example, the in-store device is configured to display the determined queue length, thereby facilitating the monitoring of queue length by members of retail store staff.

FIG. 6 is a block diagram of a computing device 400 (e.g., a server) configured to implement embodiments of the queue controller 120 (shown in FIG. 2) in accordance with embodiments of the present disclosure. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 410 included in the computing device 400 may store computer-readable and computer-executable instructions or software for implementing exemplary embodiments of the present disclosure as described herein. The computing device 400 also includes configurable and/or programmable processor 402 and associated core 404, for executing computer-readable and computer-executable instructions or software stored in the memory 410 and other programs for controlling or interfacing with system hardware 450 (e.g., sensor arrays 110, EPOS controller 300, in store device 130, and/or any other suitable system hardware.

Virtualization may be employed in the computing device 400 so that infrastructure and resources in the computing device may be shared dynamically. A virtual machine 416 may be provided to handle a process running on multiple processors so that the process appears to be using only one computing resource rather than multiple computing resources. Multiple virtual machines may also be used with one processor.

Memory 410 may include a computer system memory or random access memory, such as DRAM, SRAM, EDO RAM, and the like. Memory 410 may include other types of memory as well, or combinations thereof.

In some embodiments, a user may interact with the computing device 400 through a visual display device 418, such as a computer monitor, which may display one or more user interfaces 420 that may be provided in accordance with exemplary embodiments. The visual display device may be on a fixed terminal, portable or wearable device that is in, direct or indirect, communication with the computing device 400. The computing device 400 may be in communication with other I/O devices for receiving input from a user, for example, a keyboard or any suitable multi-point touch interface 408, a pointing device 406 (e.g., a mouse), and the like. The keyboard 408 and pointing device 406 may be coupled to the visual display device 418. The computing device 400 may include other suitable conventional I/O peripherals. memory

The computing device 400 may also include one or more storage devices 426, such as a hard-drive, CD-ROM, or other computer readable media, for implementing embodiments of the storage 130 and storing data and computer-readable instructions and/or software (e.g., code 428) that implement exemplary embodiments of the system 100 described herein. Exemplary storage device 426 may also store one or more a storage databases 430 or data logs for storing any suitable information required to implement exemplary embodiments. For example, exemplary storage device 426 can store data/information, such as baseline distance measurements, determined queue lengths, and/or any other suitable data/information for implementing embodiments of the present disclosure.

The computing device 400 can include a network interface 212 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 may include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, while the computing device 400 may be implemented as a server in example embodiments, the computing device 400 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 400 may run any operating system 414, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 414 may be run in native mode or emulated mode. In an exemplary embodiment, the operating system 414 may be run on one or more cloud machine instances.

The above-described systems and methods may advantageously allow a retail store to conveniently monitor the length of queues formed at checkouts within the retail store. These methods allow accurate feedback as to queue length, thereby assisting queue management decisions taken by members of retail store staff.

The systems and methods may also advantageously analyse the lengths of the queues present in the retail store, and recommend a course of action to reduce the queue length.

It will be appreciated that retail store staff may have a wide variety of skills and backgrounds, and the above-described embodiments provide a simple and intuitive system which may be operated with minimal training.

These advantageous systems may reduce the queuing time of customers in the retail store, thereby increasing shopper convenience and satisfaction, thus increasing sales of goods.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts

1. A measurement system comprising:
at least one sensor array disposed at a position corresponding to a respective area and comprising a plurality of sensors, each sensor configured to measure a distance in each area and transmit the measured distance;
a storage operable to store a plurality of first distances corresponding to the or each area in an empty state;
a controller configured receive a plurality of second distances from the or each sensor array, and to determine a length of a queue in each area by comparing corresponding first stored distances and second distances.

2. The system of claim 1, wherein the controller is further configured to receive the first distances from the or each sensor array and store the received first distances in the storage.

3. The system of claim 1, wherein the or each sensor array comprises at least one sensor mounted above the respective queuing area and configured to measure the distance in a downward direction.

4. The system of claim 3, wherein the or each sensor array comprises a plurality of sensors mounted above the respective area and configured to measure the distance in a downward direction mounted a predetermined distance apart.

5. The system of claim 4, wherein the or each sensor array comprises five sensors mounted above the respective area and configured to measure the distance in the downward direction.

6. The system of claim 1, wherein the or each sensor array comprises at least one sensor disposed at an end of the respective area and configured to measure the distance in a horizontal direction.

7. The system of claim 6, wherein the or each sensor array comprises two sensors disposed at opposing ends of the respective area and configured to measure the distance in the horizontal direction.

8. The system of claim 1, wherein the controller is configured to determine that the or each area is empty if the second distances are substantially equal to the first stored distances.

9. The system of claim 1, wherein the controller is configured to determine that an object is present in a region of the or each area corresponding to each sensor if the difference between the first and second distances corresponding to the sensor exceeds a predetermined threshold.

10. The system of claim 9, wherein the controller is configured to determine a start point and an end point of the queue in each area based on the presence of an object in the region of the or each area corresponding to each sensor, and to determine the length of the queue in each area based on a distance between the start point and the end point.

11. The system of claim 1, wherein at least one sensor comprises:
an emitter operable to emit a signal, and
a receiver operable to measure a quantity of the emitted signal reflected from an object, so as to determine a distance between the sensor and the object.

12. The system of claim 11, wherein the signal is modulated light.

13. The system of claim 11, wherein the signal is a laser pulse.

14. The system of claim 11, wherein the signal is a sound wave.

15. The system of claim 1, further comprising a terminal operable to receive and display measurement information,
wherein the controller is configured to periodically store the determined length of the queue in each area in the storage, and
wherein the controller is configured to control the terminal to display an alert when the controller determines that the or each length has exceeded a predetermined length for a predetermined amount of time.

16. The system of claim 3, wherein the controller is configured to determine a fill level of one or more trollies in each queuing area, based on the measured distance in the downward direction.

17. The system of claim 1, wherein each area corresponds to a controller, and the controller is configured to activate the respective sensor array of each area when the respective controller is activated.

18. A method of measuring a length comprising:
storing a plurality of first distances corresponding to an area in an empty state
obtaining a plurality of second distances using a sensor array disposed at a position corresponding to the area and comprising a plurality of sensors arranged to measure a distance in the area, and
determining a length of a queue in the area by comparing corresponding first stored distances and second distances.
